(19) United States
(12) Patent Application Publication
(10) Pub. No.: US 2026/0253228 A1
(43) Pub. Date: Aug. 27, 2026

(54) SYSTEMS AND METHODS UTILIZING IMPROVED DEFINITION OF CELL BOUNDARIES IN BIOLOGICAL IMAGES

(71) Applicant: Bruker Spatial Biology, Inc., Seattle, WA (US)

(72) Inventor: Andre ANDERSON, Seattle, WA (US)

(73) Assignee: Bruker Spatial Biology, Inc., Seattle, WA (US)

(21) Appl. No.: 19/140,025

(22) PCT Filed: Dec. 15, 2023
(86) PCT No.: PCT/US2023/084264

§ 371 Date: Jun. 17, 2025

Related U.S. Application Data
(60) Provisional application No. 63/434,361, filed on Dec. 21, 2022.

(51) Int. Cl. G06T 7/12

(52) U.S. Cl. CPC G06T 7/12; G06T 2207/10056; G06T 2207/30024

(57) ABSTRACT

Described herein are systems and methods applying improved file structure for defining cell boundaries in biological images. A non-intersecting polygon path along a cell boundary is used to mimic the cell boundary. A data structure stores cartesian coordinates of starting vertex of the polygon and polar coordinate for steps between vertices along the polygon path. Each step is stored in a single byte with 3-part bit packing. The resulting file containing the data structure defines cell boundaries in biological images with compacted storage and enhances data delivery and processing for spatial biological informatics.

### CROSS-REFERENCE

This application claims the benefit of U.S. Provisional Application No. 63/434,361, filed Dec. 21, 2022, and PCT/US 2023/084264, filed Dec. 15, 2023, which are hereby incorporated by reference in their entirety herein.

### BACKGROUND

Spatial biology studies combine whole-slide imaging at single-cell resolution to visualize and quantitate biomarker expression and reveal how cells interact and organize across the entire tissue landscape. Broadly applicable and comprehensive morphometric analysis of complex biological informatics in biological imaging data remains a challenging task.

### SUMMARY

Cells are a fundamental unit of life and investigation at the level of a single cell within a cellular environment such as a cell culture or biological tissue will provide a powerful tool for various aspects of research. Medical and biological images are quickly growing in terms of size and information content. For example, single-cell imagers use sequential cycles of probe hybridization and imaging and offer the potential to combine the benefits of scRNA-seq analysis with added spatial resolution at single-cell or even subcellular resolution while retaining cellular position information. Cell image data may be two-dimensional and/or three-dimensional. Further, spatial biology informatics “-omics” data such as genomic data, proteomic data, metabolomic data, metagenomic data, phenomic data, and/or transcriptomic data, is associated with cell image data as metadata and/or as an overlay to the image.

Image segmentation software and approaches have been applied to define cell boundaries, based on the polygon path along the cell boundaries in biological cell images. However, biological cell images may contain data for millions of cells. Storage, transferring, displaying for cell image data may require huge resources, bandwidths, and time. Most importantly, rendering the data on the client side is too slow and takes too many computing resources. GUI allows the user to pan and zoom around an image, and when doing so, the cell boundaries need to be rendered and re-rendered.

The common approach to describe the path of a polygon uses Cartesian coordinates of the starting vertex and difference in all dimensions, for example, delta X and delta Y, between the ordered neighboring pair of vertices, so that it requires at least 2 bytes to describe each step along the polygon path. Improvements to file defining cell boundaries containing data structures with less storage for each step are needed.

Accordingly, in one aspect, disclosed herein a computer-implemented method of generating a file defining biological image data comprising: a) retrieving, by a computer, cartesian coordinates of vertices of a non-intersecting polygon, and maintaining the vertices in an order from a starting vertex to a last vertex, following a polygon path around a boundary of a cell from a biological image; b) storing in a data structure, by the computer, the cartesian coordinates of the starting vertex of the polygon; c) calculating, by the computer, a distance between the starting vertex and the last vertex; d) selecting, by the computer, a matrix comprising edge elements to represent different directions based on the distance; e) assigning, by the computer, the cartesian coordinates of a first vertex from a pair of ordered neighboring vertices as a polar reference coordinate of the matrix; f) converting, by the computer, the cartesian coordinates of a second vertex from the pair of ordered neighboring vertices into a reference to the polar coordinates of the corresponding matrix; g) assigning, by the computer, a step for the first vertex from the pair of ordered neighboring vertices as an edge element of the second vertex combining the size of the matrix; h) storing in the data structure, by the computer, the step for the vertex in the order along the polygon path; i) storing in the data structure, by the computer, the steps for all vertices, by iterating e)-h); and j) generating, by the computer, from the data structure, a file defining the boundary of the cell. In some embodiments, the vertices are maintained in an array. In some embodiments, the method further comprises performing, by the computer, a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the method in h) further comprises storing a terminator for the last vertex of the polygon. In some embodiments, the method further comprises receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, the distance comprise arithmetic average value of the difference in cartesian coordinates of all dimensions. In some embodiments, the method further comprises compressing, by the computer, the data in the data structure for all vertices of the boundary of the cell. In some embodiments, the computer comprises a client-side computing device. In some embodiments, the method further comprises rendering the cell boundaries on a GUI. In some embodiments, the method further comprises rendering 100K, 500K, 1 M, 5 M, or 10 M cell boundaries. In some embodiments, the file comprises definitions of 100K, 500K, 1 M, 5 M, or 10 M cell boundaries.

In another aspect, disclosed herein is a computer-implemented system comprising at least one processor and instructions executable by the at least one processor to provide an application comprising: a) a software module retrieving cartesian coordinates of vertices of a non-intersecting polygon, and maintaining the vertices in an order from a starting vertex to a last vertex, following a polygon path around a boundary of a cell from a biological image; b) a software module storing, in a data structure, the cartesian coordinates of the starting vertex of the polygon; c) a software module calculating a distance between the starting vertex and the last vertex; d) a software module selecting a matrix comprising edge elements to represent different directions based on the distance; e) a software module assigning the cartesian coordinates of a first vertex from a pair of ordered neighboring vertices as a polar reference coordinate of the matrix; f) a software module converting the cartesian coordinates of a second vertex from the pair of ordered neighboring vertices into a reference to the polar coordinates of the corresponding matrix; g) a software module assigning a step for the first vertex from the pair of ordered neighboring vertices as an edge element of the second vertex combining the size of the matrix; h) a software module storing, in the data structure the step for the vertex in the order along the polygon path; i) a software module storing, in the data structure, the steps for all vertices, by iterating e)-h); and j) a software module generating, from the data structure, a file defining the boundary of the cell. In some embodiments, the vertices are maintained in an array. In some embodiments, the application further comprises a software module performing a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the software module in h) further comprises storing a terminator for the last vertex of the polygon. In some embodiments, the application further comprises a software module receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, in the distance comprise arithmetic average value of the difference in cartesian coordinates of all dimensions. In some embodiments, the application further comprises a software module compressing, the data in the data structure for all vertices of the boundary of the cell. In some embodiments, the system further comprises a client-side computing device. In some embodiments, the application further comprises a software module rendering the cell boundaries on a GUI. In some embodiments, the software module further comprises rendering 100K, 500K, 1 M, 5 M, or 10 M cell boundaries. In some embodiments, the file comprises definitions of 100K, 500K, 1 M, 5 M, or 10 M cell boundaries.

In another aspect, disclosed herein is a non-transitory computer-readable storage media encoded with instructions executable by one or more processors to cause the one or more processors to perform operations comprising: a) retrieving cartesian coordinates of vertices of a non-intersecting polygon; b) maintaining the vertices in an order from a starting vertex to a last vertex, following a polygon path around a boundary of a cell from a biological image; c) storing, in a data structure, the cartesian coordinates of the starting vertex of the polygon; d) calculating a distance between the starting vertex and the last vertex; e) selecting a matrix comprising edge elements to represent different directions based on the distance; f) assigning the cartesian coordinates of a first vertex from a pair of ordered neighboring vertices as a polar reference coordinate of the matrix; g) converting the cartesian coordinates of a second vertex from the pair of ordered neighboring vertices into a reference to the polar coordinates of the corresponding matrix; h) assigning a step for the first vertex from the pair of ordered neighboring vertices as an edge element of the second vertex combining the size of the matrix; i) storing, in the data structure, the step for the vertex in the order along the polygon path; j) storing, in the data structure, the steps for all vertices, by iterating f)-i); and k) generating, from the data structure, a file defining the boundary of the cell. In some embodiments, the vertices are maintained in an array. In some embodiments, the operations further comprise performing a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the operations in i) further comprise storing a terminator for the last vertex of the polygon. In some embodiments, the operations further comprise receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, the distance comprise arithmetic average value of the difference in cartesian coordinates of all dimensions. In some embodiments, the operations further comprise compressing, the data in the data structure for all vertices of the boundary of the cell. In some embodiments, the non-transitory computer-readable storage media further comprises a client-side computing device. In some embodiments, the operations further comprise rendering the cell boundaries on a GUI. In some embodiments, the operations further comprise rendering 100K, 500K, 1 M, 5 M, or 10 M cell boundaries. In some embodiments, the file comprises definitions of 100K, 500K, 1 M, 5 M, or 10 M cell boundaries.

In various embodiments, image segmentation software based on machine learning (ML) algorithms may be applied to create cell boundaries from fluorescent images of protein assays. In some embodiments, the protein assays may comprise protein antibodies binding to membrane proteins. In some embodiments, ML algorithms applied to image segmentation may comprise semantic segmentation, instance segmentation, generative networks for segmentation. In some embodiments, image segmentation software may comprise ImageJ, CellProfiller, Cellpose, Ilastik, and/or QuPath.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a computing device; in this case, a device with one or more processors, memory, storage, and a network interface;

FIG. 2 shows a non-limiting example of a web/mobile application provision system; in this case, a system providing browser-based and/or native mobile user interfaces;

FIG. 3 shows a non-limiting example of a cloud-based web/mobile application provision system; in this case, a system comprising an elastically load balanced, auto-scaling web server and application server resources as well synchronously replicated databases;

FIGS. 4A and 4B show a non-limiting example of a matrix; in this case, the edges of the matrix hold a number indicating a reference to the polar coordinates created from the center to the edge where the number lies in the perimeter;

FIG. 5 shows a non-limiting example of fast polygon self-intersection test for moving vertex;

FIGS. 6A and 6B show a non-limiting example for fast polygon mask fill leveraging line orientation; and

FIGS. 7A-7E show a non-limiting example of validation of cell segmentation as illustrated in Example 2.

### INCORPORATION BY REFERENCE

All publications, patents, and patent applications mentioned in this specification are herein incorporated by reference for the specific purposes identified herein.

### DETAILED DESCRIPTION

Described herein, in certain embodiments, are a computer-implemented method of generating a file defining biological image data comprising: a) retrieving, by a computer, cartesian coordinates of vertices of a non-intersecting polygon, and maintaining the vertices in an order from a starting vertex to a last vertex, following a polygon path around a boundary of a cell from a biological image; b) storing in a data structure, by the computer, the cartesian coordinates of the starting vertex of the polygon; c) calculating, by the computer, a distance between the starting vertex and the last vertex; d) selecting, by the computer, a matrix comprising edge elements to represent different directions based on the distance; e) assigning, by the computer, the cartesian coordinates of a first vertex from a pair of ordered neighboring vertices as a polar reference coordinate of the matrix; f) converting, by the computer, the cartesian coordinates of a second vertex from the pair of ordered neighboring vertices into polar coordinates of the matrix; g) assigning, by the computer, a step for the first vertex from the pair of ordered neighboring vertices as an edge element of the second vertex combining the size of the matrix; h) storing in the data structure, by the computer, the step for the vertex in the order along the polygon path; i) storing in the data structure, by the computer, the steps for all vertices, by iterating e)-h); and j) generating, by the computer, from the data structure, a file defining the boundary of the cell. In some embodiments, the vertices are maintained in an array. In some embodiments, the method further comprises performing, by the computer, a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the method in h) further comprises storing a terminator for the last vertex of the polygon. In some embodiments, the method further comprises receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, the distance comprise arithmetic average value of the difference in cartesian coordinates of all dimensions. In some embodiments, the method further comprises compressing, by the computer, the data in the data structure for all vertices of the boundary of the cell. In some embodiments, the computer comprises a client-side computing device. In some embodiments, the method further comprises rendering the cell boundaries on a GUI. In some embodiments, the method further comprises rendering 100K, 500K, 1 M, 5 M, or 10 M cell boundaries. In some embodiments, the file comprises definitions of 100K, 500K, 1 M, 5 M, or 10 M cell boundaries.

Also described herein, in certain embodiments, are a computer-implemented system comprising at least one processor and instructions executable by the at least one processor to provide an application comprising: a) a software module retrieving cartesian coordinates of vertices of a non-intersecting polygon, and maintaining the vertices in an order from a starting vertex to a last vertex, following a polygon path around a boundary of a cell from a biological image; b) a software module storing, in a data structure, the cartesian coordinates of the starting vertex of the polygon; c) a software module calculating a distance between the starting vertex and the last vertex; d) a software module selecting a matrix comprising edge elements to represent different directions based on the distance; e) a software module assigning the cartesian coordinates of a first vertex from a pair of ordered neighboring vertices as a polar reference coordinate of the matrix; f) a software module converting the cartesian coordinates of a second vertex from the pair of ordered neighboring vertices into polar coordinates of the matrix; g) a software module assigning a step for the first vertex from the pair of ordered neighboring vertices as an edge element of the second vertex combining the size of the matrix; h) a software module storing, in the data structure the step for the vertex in the order along the polygon path; i) a software module storing, in the data structure, the steps for all vertices, by iterating e)-h); and j) a software module generating, from the data structure, a file defining the boundary of the cell. In some embodiments, the vertices are maintained in an array. In some embodiments, the application further comprises a software module performing a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the software module in h) further comprises storing a terminator for the last vertex of the polygon. In some embodiments, the application further comprises a software module receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, in the distance comprise arithmetic average value of the difference in cartesian coordinates of all dimensions. In some embodiments, the application further comprises a software module compressing, the data in the data structure for all vertices of the boundary of the cell. In some embodiments, the system further comprises a client-side computing device. In some embodiments, the application further comprises a software module rendering the cell boundaries on a GUI. In some embodiments, the software module further comprises rendering 100K, 500K, 1 M, 5 M, or 10 M cell boundaries. In some embodiments, the file comprises definitions of 100K, 500K, 1 M, 5 M, or 10 M cell boundaries.

Also described herein, in certain embodiments, are non-transitory computer-readable storage media encoded with instructions executable by one or more processors to cause the one or more processors to perform operations comprising: a) retrieving cartesian coordinates of vertices of a non-intersecting polygon; b) maintaining the vertices in an order from a starting vertex to a last vertex, following a polygon path around a boundary of a cell from a biological image; c) storing, in a data structure, the cartesian coordinates of the starting vertex of the polygon; d) calculating a distance between the starting vertex and the last vertex; e) selecting a matrix comprising edge elements to represent different directions based on the distance; f) assigning the cartesian coordinates of a first vertex from a pair of ordered neighboring vertices as a polar reference coordinate of the matrix; g) converting the cartesian coordinates of a second vertex from the pair of ordered neighboring vertices into polar coordinates of the matrix; h) assigning a step for the first vertex from the pair of ordered neighboring vertices as an edge element of the second vertex combining the size of the matrix; i) storing, in the data structure, the step for the vertex in the order along the polygon path; j) storing, in the data structure, the steps for all vertices, by iterating f)-i); and k) generating, from the data structure, a file defining the boundary of the cell. In some embodiments, the vertices are maintained in an array. In some embodiments, the operations further comprise performing a quality assurance check on the received cartesian coordinates of vertices of a non-intersecting polygon, wherein the quality assurance check comprises one or more of: checking that the polygon comprises at least 3 vertices; checking that the polygon path comprises a closed loop; checking that polygon path comprises an established direction; and checking that the order of the vertices following the polygon path comprises a sequential order. In some embodiments, the step comprises a long step. In some embodiments, the step comprises a short step. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix. In some embodiments, the data structure comprises 1-bit, 2-bit, 3-bit, 4-bit, 5-bit, 6-bit, 7-bit, or 8-bit for storing each step. In some embodiments, the data structure comprises 1-byte, 2-byte, 3-byte, or 4-byte for storing each step. In some embodiments, the operations in i) further comprise storing a terminator for the last vertex of the polygon. In some embodiments, the operations further comprise receiving the biological image. In some embodiments, the biological image comprises a 2D image. In some embodiments, the cartesian coordinates are 2D coordinates. In some embodiments, the biological image comprises a 3D image. In some embodiments, the cartesian coordinates are 3D coordinates. In some embodiments, the distance comprises Euclidean distance. In some embodiments, the distance comprises the difference in cartesian coordinates of one dimension. In some embodiments, the distance comprises the maximum value of the difference in cartesian coordinates of all dimensions. In some embodiments, the distance comprises the minimum value of the difference in cartesian coordinates of all dimensions. In some embodiments, the distance comprise arithmetic average value of the difference in cartesian coordinates of all dimensions. In some embodiments, the operations further comprise compressing, the data in the data structure for all vertices of the boundary of the cell. In some embodiments, the non-transitory computer-readable storage media further comprises a client-side computing device. In some embodiments, the operations further comprise rendering the cell boundaries on a GUI. In some embodiments, the operations further comprise rendering 100K, 500K, 1 M, 5 M, or 10 M cell boundaries. In some embodiments, the file comprises definitions of 100K, 500K, 1 M, 5 M, or 10 M cell boundaries.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing System

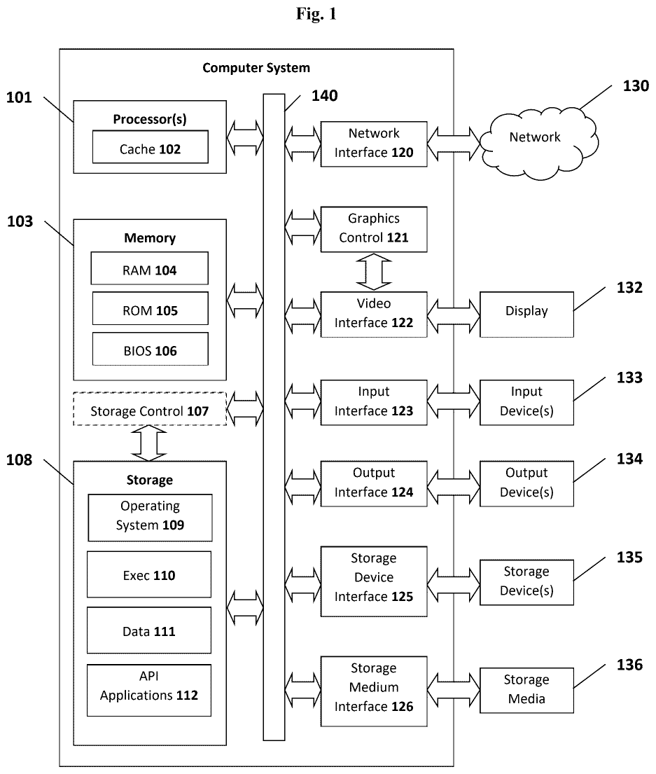

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, and personal digital assistants.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® . NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

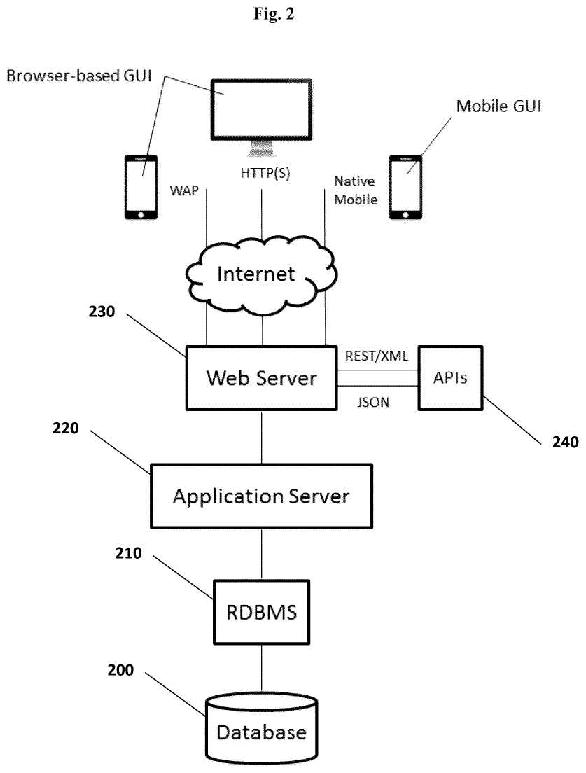

Referring to FIG. 2, in a particular embodiment, an application provision system comprises one or more databases 200 accessed by a relational database management system (RDBMS) 210. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 220 (such as Java servers, .NET servers, PHP servers, and the like) and one or more web servers 230 (such as Apache, IIS, GWS and the like). The web server(s) optionally expose one or more web services via app application programming interfaces (APIs) 240. Via a network, such as the Internet, the system provides browser-based and/or mobile native user interfaces.

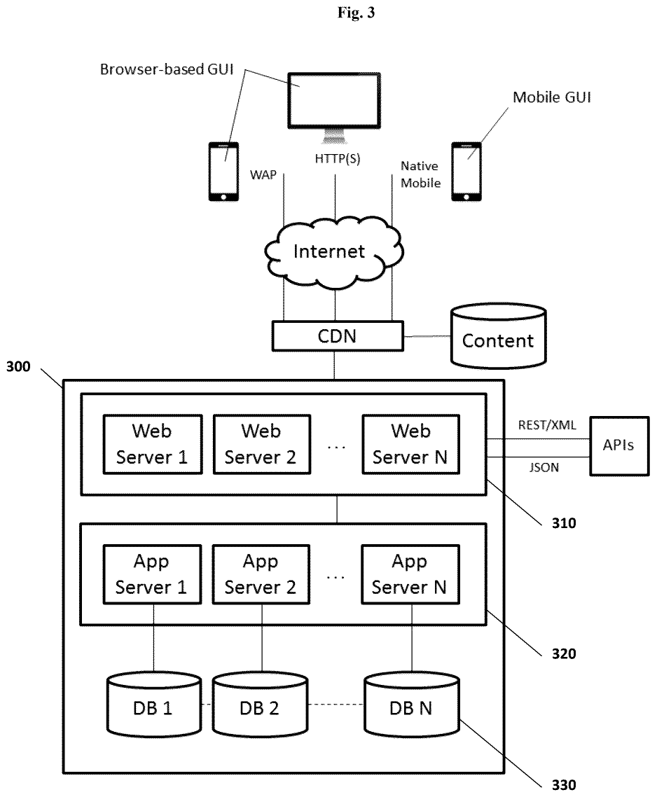

Referring to FIG. 3, in a particular embodiment, an application provision system alternatively has a distributed, cloud-based architecture 300 and comprises elastically load balanced, auto-scaling web server resources 310 and application server resources 320 as well synchronously replicated databases 330.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB. NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, . NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB . NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user information, study information, slide information, field of view (FoV) information, flow cell information, image information, including cell boundaries, genomic information, transcriptomic information, and proteomic information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing based. In a particular embodiment, a database is a distributed database. In other embodiments, a database is based on one or more local computer storage devices.

### Data Retrieval

In some embodiments, the methods, systems, and media disclosed herein receive data from laboratory instruments. In some embodiments, the data is received directly from one or more laboratory instruments. In other embodiments, the data is received indirectly from one or more laboratory instruments. In some embodiments, the methods, systems, and media disclosed herein receive data from databases. In some embodiments, the data is received directly from databases. In other embodiments, the data is received indirectly from databases. Many types of data are suitable. In the field of spatial biology, useful data includes, by way of non-limiting examples, biological image data such as microscopy images (e.g., micrographs) of formalin fixed paraffin embedded (FFPE) and/or fresh frozen (FF) samples of cells and/or tissues. In some embodiments, biological image data comprises cell image data. In some embodiments, the image data comprises two-dimensional data. In some embodiments, the image data comprises three-dimensional image data. In some embodiments, data from a single slide for RNA Assays and Protein Assays is split into two datasets. In some embodiments, data from a single slide for RNA assays and Protein Assays is combined. Further, in the field of spatial biology, useful data includes, by way of non-limiting examples, “-omics” data such as genomic data, proteomic data, metabolomic data, metagenomic data, phenomic data, and/or transcriptomic data. In some embodiments, the -omics data is associated with the image data. For example, in various embodiments the -omics data may be generated from the same tissue, the same sample or the same type of cells as the image data. In further embodiments, the -omics data is spatially associated with the image data in two and/or three-dimensions. In various embodiments, the -omics data is associated with the image data as metadata and/or as an overlay to the image.

In some embodiments, the methods, systems, and media disclosed herein may receive data via an instrument interface and keep it in its original file format. In some embodiments, the platforms, systems, media, and methods disclosed herein may receive data via an instrument interface and add it to dataset(s).

### Non-intersecting Polygon

In some embodiments, the methods, systems, and media disclosed herein may comprise receiving cell image data. In some embodiments, the cell image data comprises data of cell boundaries. In some embodiments, data of cell boundaries comprises cartesian coordinates of vertices of a non-intersecting polygon following a polygon path around a boundary of a cell. In some embodiments, the cartesian coordinates comprise 2D coordinates. In some embodiments, the cartesian coordinates comprises 3D coordinates. In some embodiments, the cartesian coordinates of vertices may be recorded in an ordered data structure, i.e., an array. In some embodiments, the order comprises the order from a starting vertex to a last vertex, following the polygon path around the boundary of the cell. In some embodiments, the cell image data comprises data input from a system user. In some embodiments, the cell image data comprises data from an algorithm. In some embodiments, the cell image data comprises data input from a system user in combination with data from an algorithm.

In some embodiments, the methods, systems, and media disclosed herein may comprise performing a quality assurance check. In some embodiments, the quality assurance check may comprise checking on cartesian coordinates of vertices of a non-intersecting polygon received. In some embodiments, the quality assurance check comprises one of more of: a) checking that the polygon comprises at least 3 vertices; b) checking that the polygon path comprises a closed loop; c) checking that polygon path comprises an established direction; and d) checking that the order of the vertices following the polygon path comprises a sequential order.

In various embodiments, the methods, systems, and media disclosed herein further comprises a client-side computing device. In various embodiments, the methods, systems, and media disclosed herein further comprises rendering the cell boundaries on a GUI. In various embodiments, the GUI may allow a user to move a vertex of the polygon along a cell boundary. In various embodiments, the GUI may allow a user to re-display a cell boundary after moving a vertex of the polygon along the cell boundary.

In some embodiments, the methods, systems, and media disclosed herein may further comprise a fast polygon self-intersection test for moving vertex. The common method of testing for a polygon self-intersection of its line segments is to compare each segment to every other line segment in the polygon. The common approach has a complexity of O(N²), where N is the number of line segments in the polygon. In some embodiments, the fast polygon self-intersection test may comprise identifying the moving vertex. In some embodiments, the fast polygon self-intersecting test may further comprise comparing the two line segments connected to the moving vertex, to every other line segment(s). In some embodiments, the fast polygon self-intersection test may comprise a complexity of O(N), where N is the number of line segment(s) in the polygon. In some embodiments, the improvement in speed may provide a higher framerate for user interface. In some embodiments, the improvement in speed may provide a higher smoothness of control for user interface. In some embodiments, the improvement in speed may allow a user to modify the shape of a complex polygon in real time.

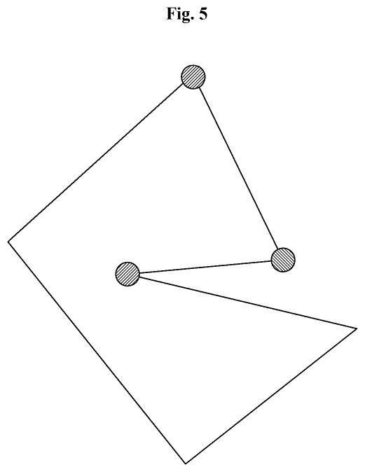

As illustrated in FIG. 5, in a hexagon ABCDEF, vertex A is being moved. A line intersecting test will be conducted, based on the pre-calculated orientation of vectors of AB and AF, to line segments of BC, CD, DE, and EF. The common approach will test for each of the six line segments, against five other line segments, and it will be a total of 30 calculations. The fast polygon self-intersection test takes consideration that AB and AF are the only two line segments affected by moving vertex A, so the intersecting test will be conducted only for AB and AF. In this example, the remaining 4 line segments will not be re-calculated. The fast polygon self-intersecting test takes further into consideration that neighboring line segments (e.g., those sharing a common vertex) never need to be tested for intersection. This results in a total test including 6 calculations in the example, instead of 30 calculations in the common approach.

In some embodiments, the methods, systems, and media disclosed herein may further comprise a fast polygon mask fill approach leveraging line orientation. The common approach for filling a polygon is to use a Digital Differential Analyzer (DDA) or Bresenham line drawing algorithm to draw the line segments of a polygon as pixels; and then a scan fill algorithm to look for edge pair intersection along each horizontal row, which requires some extra calculation such as division. Then the scan fill algorithm is used to sort the edge pairs, and to fill the pixels in between each edge pair. The common approach has a complexity of O(N) for the line segment drawing part, and a complexity of O(Nlog(N)) for the scan fill algorithm. In some embodiments, the fast polygon mask filling approach may comprise preserving the context of each line's orientation when drawing the pixels of the line segments. In some embodiments, the fast polygon mask filling approach further comprises recording a condition value with an outside edge pixel. In some embodiments, the condition value comprises left, right, or shared. In some embodiments, the fast polygon mask filling approach comprises directly filling without sorting the edge pairs. In some embodiments, the fast polygon mask filling approach may comprise a complexity of O(N) for line segment drawing. In some embodiments, the fast polygon mask filling approach may comprise a complexity of O(N) for polygon filling.

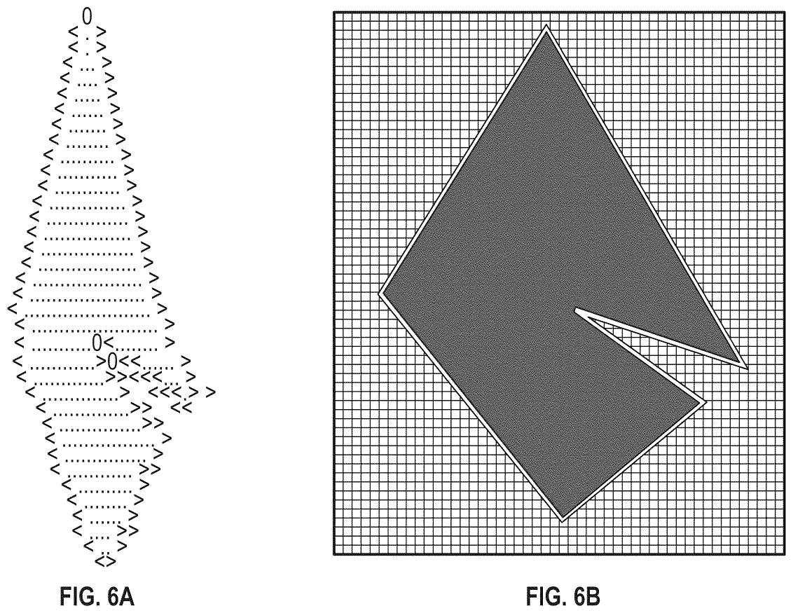

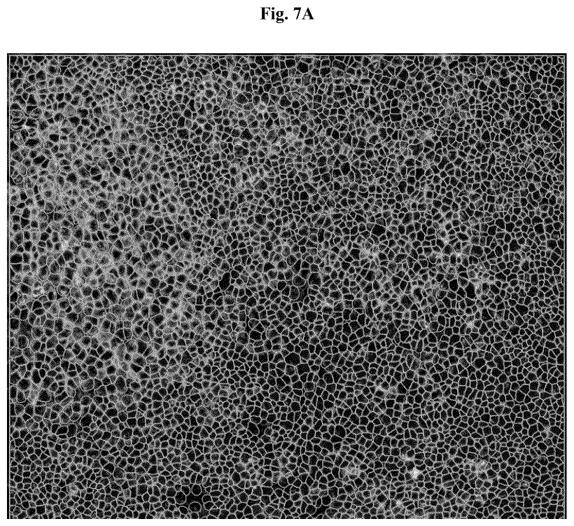

As illustrated in FIG. 6B, a polygon with a white edge and the interior is filled by applying the fast polygon mask filling approach. Polygon vertices are located at (12, 0), (0, 19), (13, 36), (24, 27), (14, 21), (27, 25), when counting from counterclockwise starting from the top. The pixels of the polygon are listed as illustrated in FIG. 6A. For each inner pixel there has a dot assigned. For each edge pixel, there has one of the three values assigned: “O” represents for shared edge pixel, “<” represents for left edge pixel, and “>” represents for right edge pixel. Matrix

In some embodiments, the methods, systems, and media disclosed herein may further comprise calculating a distance between the starting vertex and the last vertex. In some embodiments, the distance comprises Euclidean distance. In some embodiments, the distance comprises difference in cartesian coordinates of one dimension, i.e., delta x, delta y, or delta z. In some embodiments, the distance comprises the maximum value of the difference in cartesian coordinates of all dimensions, i.e., maximum value of delta x and delta y or maximum value of delta x and delta y and delta z. In some embodiments, the distance comprises the minimum value of the difference in cartesian coordinates of all dimensions, i.e., minimum value of delta x and delta y or minimum value of delta x and delta y and delta z. In some embodiments, the distance comprises the arithmetic average value of the difference in cartesian coordinates of all dimensions, i.e., average value of delta x and delta y, or average value of delta x and delta z, or average value of delta y and delta z, or average value of delta x and delta y and delta z.

In some embodiments, the methods, systems, and media disclosed herein may further comprise selecting a matrix comprising edge elements to represent different directions based on the distance. In some embodiments, the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix.

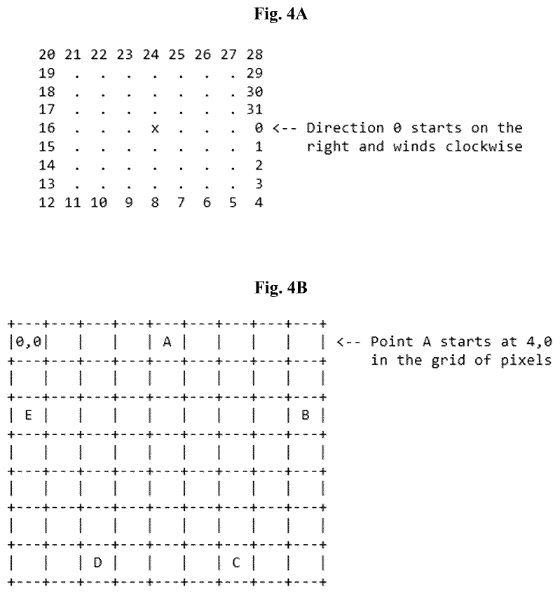

FIG. 4A illustrates a non-limiting example of a matrix of 9×9. The polar reference of the matrix is labeled by an X at the center. On the edge of the matrix, numbers 0 to 31 are listed clockwise, with number 0 starts on the right. The 32 numbers represent different directions between a pair of neighboring vertices. The distance from the polar reference (X) to the edge is 4 (pixels) for all directions. Similarly, in a matrix of 17×17, the distance from the polar reference to the edge is 8 (pixels) for all directions. There are 64 numbers (0-63) representing different directions located on the edge of the matrix of 17×17. The polar coordinates (e.g., distance of 4 or 8, and number representing the different directions) from this matrix could be used to define a step between a pair of ordered neighboring vertices, along the polygon path on a cell boundary. In some embodiments, the distance is fixed for a polygon path along the cell boundary. In some embodiments, the step comprises a short step. In some embodiments, the step comprises a long step.

In some embodiments, the short step comprises the distance of about 1 pixel, about 2 pixels, about 3 pixels, about 4 pixels, about 5 pixels, about 6 pixels, about 7 pixels, or about 8pixels. In some embodiments, the short step comprises the distance from about 1 pixel to about 8 pixels, from about 1 pixel to about 7 pixels, from about 1 pixel to about 6 pixels, from about 1 pixel to about 5 pixels, from about 1 pixel to about 4 pixels, from about 1 pixel to about 3 pixels, from about 1 pixel to about 2 pixels, from about 2 pixels to about 8 pixels, from about 2 pixels to about 7 pixels, from about 2 pixels to about 6 pixels, from about 2 pixels to about 5 pixels, from about 2 pixels to about 4 pixels, from about 2 pixels to about 3 pixels, from about 3 pixels to about 8 pixels, from about 3 pixels to about 7 pixels, from about 3 pixels to about 6 pixels, from about 3 pixels to about 5 pixels, from about 3 pixels to about 4 pixels, from about 4 pixels to about 8 pixels, from about 4 pixels to about 7 pixels, from about 4 pixels to about 6 pixels, from about 4 pixels to about 5 pixels, from about 5 pixels to about 8 pixels, from about 5 pixels to about 7 pixels, from about 5 pixels to about 6 pixels, from about 6 pixels to about 8 pixels, from about 6 pixels to about 7 pixels, or from about 7 pixels to about 8 pixels. In some embodiments, the short step comprises the distance at least about 1 pixel, at least about 2 pixels, at least about 3 pixels, at least about 4 pixels, at least about 5 pixels, at least about 6 pixels, at least about 7 pixels, or at least about 8 pixels. In some embodiments, the short step comprises the distance at most about 1 pixel, at most about 2 pixels, at most about 3 pixels, at most about 4 pixels, at most about 5 pixels, at most about 6 pixels, at most about 7 pixels, or at most about 8 pixels.

In some embodiments, the long step comprises the distance about 4 pixels, about 5 pixels, about 6 pixels, about 7 pixels, about 8 pixels, about 9 pixels, about 10 pixels, about 11 pixels, about 12 pixels, about 14 pixels, or about 16 pixels. In some embodiments, the long step comprises the distance from about 4 pixels to about 16 pixels, from about 4 pixel to about 14 pixels, from about 4 pixel to about 12 pixels, from about 4 pixel to about 11 pixels, from about 4 pixel to about 10 pixels, from about 4 pixel to about 9 pixels, from about 4 pixel to about 8 pixels, from about 4 pixel to about 7 pixels, from about 4 pixel to about 6 pixels, from about 4 pixel to about 5 pixels, from about 5 pixel to about 16 pixels, from about 5 pixel to about 14 pixels, from about 5 pixel to about 12 pixels, from about 5 pixel to about 11 pixels, from about 5 pixel to about 10 pixels, from about 5 pixel to about 9 pixels, from about 5 pixel to about 8 pixels, from about 5 pixel to about 7 pixels, from about 5 pixel to about 6 pixels, from about 6 pixel to about 16 pixels, from about 6 pixel to about 14 pixels, from about 6 pixel to about 12 pixels, from about 6 pixel to about 11 pixels, from about 6 pixel to about 10 pixels, from about 6 pixel to about 9 pixels, from about 6 pixel to about 8 pixels, from about 6 pixel to about 7 pixels, from about 7 pixel to about 16 pixels, from about 7 pixel to about 14 pixels, from about 7 pixel to about 12 pixels, from about 7 pixel to about 11 pixels, from about 7 pixel to about 10 pixels, from about 7 pixel to about 9 pixels, from about 7 pixel to about 8 pixels, from about 8 pixel to about 16 pixels, from about 8 pixel to about 14 pixels, from about 8 pixel to about 12 pixels, from about 8 pixel to about 11 pixels, from about 8 pixel to about 10 pixels, from about 8 pixel to about 9 pixels, from about 9 pixel to about 16 pixels, from about 9 pixel to about 14 pixels, from about 9 pixel to about 12 pixels, from about 9 pixel to about 11 pixels, from about 9 pixel to about 10 pixels, from about 10 pixel to about 16 pixels, from about 10 pixel to about 14 pixels, from about 10 pixel to about 12 pixels, from about 10 pixel to about 11 pixels, from about 11 pixel to about 16 pixels, from about 11 pixel to about 14 pixels, from about 11 pixel to about 12 pixels, from about 12 pixel to about 16 pixels, from about 12 pixel to about 14 pixels, or from about 14 pixel to about 16 pixels. In some embodiments, the long step comprises the distance at least about 4 pixels, at least about 5 pixels, at least about 6 pixels, at least about 7 pixels, at least about 8 pixels, at least about 9 pixels, at least about 10 pixels, at least about 11 pixels, at least about 12 pixels, at least about 14 pixels, or at least about 16 pixels. In some embodiments, the long step comprises the distance at most about 4 pixels, at most about 5 pixels, at most about 6 pixels, at most about 7 pixels, at most about 8 pixels, at most about 9 pixels, at most about 10 pixels, at most about 11 pixels, at most about 12 pixels, at most about 14 pixels, or at most about 16 pixels.

FIG. 4B illustrates a non-limiting example of a cell boundary represented by a pentagon ABCDE in a cartesian coordinate. A is the starting vertex and the last vertex is E. All vertices are located a distance of 4 (pixels) from each other. This is determined by the distance between the starting vertex and last vertex (in this case between A and E). To calculate the step from A to B, the cartesian coordinates of vertex A, the first vertex from the ordered pair neighboring vertices (AB), is assigned to the polar reference coordinate of the matrix. For example, placing vertex A on the “X”, located at the center of the matrix in FIG. 4A. Following the transformation in coordinates, then vertex B, the second vertex from the ordered pair neighboring vertices, will be on the edge of matrix with the number “2”. So, the step A to B could be represented by “2” for the direction. Following the path, step B to C could be calculated by following the same polar coordination transformation: vertex B is transferred to the “X” at the center of the matrix in FIG. 4A, and vertex C is then located at the edge marked “10”. So, the step BC is 10 for direction. Following the same conversion, step C to D will be 16 and step D to E will be 22.

### Data Structure

In some embodiments, the methods, systems, and media disclosed herein may further comprise storing the cartesian coordinates of the starting vertex in a data structure. In some embodiments, the methods, systems, and media disclosed herein may further comprise storing the steps of the polygon path along the cell boundary in the data structure. In some embodiments, the data structure comprises 1-bit, 2-bit, 3-bit, 4-bit, 5-bit, 6-bit, 7-bit, 8-bit, 9-bit, 10-bit, 11-bit, 12-bit, 13-bit, 14-bit, 15-bit, or 16-bit for storing each step. In some embodiments, the data structure comprises at least 1-bit, at least 2-bit, at least 3-bit, at least 4-bit, at least 5-bit, at least 6-bit, at least 7-bit, at least 8-bit, at least 9-bit, at least 10-bit, at least 11-bit, at least 12-bit, at least 13-bit, at least 14-bit, at least 15-bit, or at least 16-bit for storing each step. In some embodiments, the data structure comprises from about 1-bit to about 16-bit, from about 1-bit to about 15-bit, from about 1-bit to about 14-bit, from about 1-bit to about 13-bit, from about 1-bit to about 12-bit, from about 1-bit to about 11-bit, from about 1-bit to about 10-bit, from about 1-bit to about 9-bit, from about 1-bit to about 8-bit, from about 1-bit to about 7-bit, from about 1-bit to about 6-bit, from about 1-bit to about 5-bit, from about 1-bit to about 4-bit, from about 1-bit to about 3-bit, from about 1-bit to about 2-bit, from about 2-bit to about 16-bit, from about 2-bit to about 15-bit, from about 2-bit to about 14-bit, from about 2-bit to about 13-bit, from about 2-bit to about 12-bit, from about 2-bit to about 11-bit, from about 2-bit to about 10-bit, from about 2-bit to about 9-bit, from about 2-bit to about 8-bit, from about 2-bit to about 7-bit, from about 2-bit to about 6-bit, from about 2-bit to about 5-bit, from about 2-bit to about 4-bit, from about 2-bit to about 3-bit, from about 3-bit to about 16-bit, from about 3-bit to about 15-bit, from about 3-bit to about 14-bit, from about 3-bit to about 13-bit, from about 3-bit to about 12-bit, from about 3-bit to about 11-bit, from about 3-bit to about 10-bit, from about 3-bit to about 9-bit, from about 3-bit to about 8-bit, from about 3-bit to about 7-bit, from about 3-bit to about 6-bit, from about 3-bit to about 5-bit, from about 3-bit to about 4-bit, from about 4-bit to about 16-bit, from about 4-bit to about 15-bit, from about 4-bit to about 14-bit, from about 4-bit to about 13-bit, from about 4-bit to about 12-bit, from about 4-bit to about 11-bit, from about 4-bit to about 10-bit, from about 4-bit to about 9-bit, from about 4-bit to about 8-bit, from about 4-bit to about 7-bit, from about 4-bit to about 6-bit, from about 4-bit to about 5-bit, from about 5-bit to about 16-bit, from about 5-bit to about 15-bit, from about 5-bit to about 14-bit, from about 5-bit to about 13-bit, from about 5-bit to about 12-bit, from about 5-bit to about 11-bit, from about 5-bit to about 10-bit, from about 5-bit to about 9-bit, from about 5-bit to about 8-bit, from about 5-bit to about 7-bit, from about 5-bit to about 6-bit, from about 6-bit to about 16-bit, from about 6-bit to about 15-bit, from about 6-bit to about 14-bit, from about 6-bit to about 13-bit, from about 6-bit to about 12-bit, from about 6-bit to about 11-bit, from about 6-bit to about 10-bit, from about 6-bit to about 9-bit, from about 6-bit to about 8-bit, from about 6-bit to about 7-bit, from about 7-bit to about 16-bit, from about 7-bit to about 15-bit, from about 7-bit to about 14-bit, from about 7-bit to about 13-bit, from about 7-bit to about 12-bit, from about 7-bit to about 11-bit, from about 7-bit to about 10-bit, from about 7-bit to about 9-bit, from about 7-bit to about 8-bit, from about 8-bit to about 16-bit, from about 8-bit to about 15-bit, from about 8-bit to about 14-bit, from about 8-bit to about 13-bit, from about 8-bit to about 12-bit, from about 8-bit to about 11-bit, from about 8-bit to about 10-bit, from about 8-bit to about 9-bit, from about 9-bit to about 16-bit, from about 9-bit to about 15-bit, from about 9-bit to about 14-bit, from about 9-bit to about 13-bit, from about 9-bit to about 12-bit, from about 9-bit to about 11-bit, from about 9-bit to about 10-bit, from about 10-bit to about 16-bit, from about 10-bit to about 15-bit, from about 10-bit to about 14-bit, from about 10-bit to about 13-bit, from about 10-bit to about 12-bit, from about 10-bit to about 11-bit, from about 11-bit to about 16-bit, from about 11-bit to about 15-bit, from about 11-bit to about 14-bit, from about 11-bit to about 13-bit, from about 11-bit to about 12-bit, from about 12-bit to about 16-bit, from about 12-bit to about 15-bit, from about 12-bit to about 14-bit, from about 12-bit to about 13-bit, from about 13-bit to about 16-bit, from about 13-bit to about 15-bit, from about 13-bit to about 14-bit, from about 14-bit to about 16-bit, from about 14-bit to about 15-bit, or from about 15-bit to about 16-bit for storing each step.

In some embodiments, the data structure comprises 1-byte, 2-byte, 3-byte, or 4-byte for storing each step. In some embodiments, the data structure comprises from about 1-byte to about 4-bybe, from about 1-byte to about 3-bybe, from about 1-byte to about 2-bybe, from about 2-byte to about 4-bybe, from about 2-byte to about 3-bybe, or from about 3-byte to about 4-bybe for storing each step. In some embodiments, the data structure comprises at most 1-byte, at most 2-byte, at most 3-byte, or at most 4-byte for storing each step. In some embodiments, the data structure comprises at least 1-byte, at least 2-bybe, at least 3-byte, at least 3-byte, or at least 4-byte for storing each step.

The common approach to describe the path of a polygon uses Cartesian coordinates of the starting vertex and differences in all dimensions, for example, delta X and delta Y, between the ordered neighboring pair of vertices, so that it requires at least 2 whole bytes to describe each step along the polygon path. In various embodiments, the methods, systems, and media disclosed herein comprises a data structure comprising 3-part bit packing of data into a single byte to represent short or long steps based on polar coordinates. After the cartesian coordinates of the starting vertex is stored in the data structure, the polar coordinate of each step in a sequential order along the polygon path is stored in 1-byte. The first part of the byte is used for storing the direction of the step. As illustrated in FIG. 4A, for a non-limiting example, when selecting a 9×9 matrix with directions on the edge for a short step, the direction of each step could be represented by a number from 0-31, which is up to 5-bit. Similarly, when selecting a 17×17 matrix for a long step, as a non-limiting example, the direction of each step could be represented by a number from 0-63, which is up to 6-bit. The second part of the byte is used for indicating a long or short step. The long step or short step indicator could be stored as the 7^{th} bit in the data structure. The third part of the byte is designated to a terminator of the path. When storing the step of the last vertex, a terminator could be stored in the data structure as the 8^{th} bit for the last step. The result being that only 1-byte with 3 parts is used to record each step. All steps of the polygon path will be stored in such 1-byte in sequential order, following the cartesian coordinates of the starting vertex. The last byte (step) will contain a terminator in the last bit. In various embodiments, the methods, systems, and media disclosed herein further comprises compressing the data in the structure.

In various embodiments, a file containing the data structure defining the boundary of the cell. In some embodiments, the file comprises reducing storage size for cell boundaries by about 10%, about 20%, about 30%, about 40%, about 50%, about 60%, about 70%, about 80%, or about 90%. In some embodiments, the file comprises reducing storage size for cell boundaries by at least about 10%, at least about 20%, at least about 30%, at least about 40%, at least about 50%, at least about 60%, at least about 70%, at least about 80%, or at least about 90%. In some embodiments, the file comprises reducing storage size for cell boundaries by from about 10% to about 90%, from about 10% to about 80%, from about 10% to about 70%, from about 10% to about 60%, from about 10% to about 50%, from about 10% to about 40%, from about 10% to about 30%, from about 10% to about 20%, from about 20% to about 90%, from about 20% to about 80%, from about 20% to about 70%, from about 20% to about 60%, from about 20% to about 50%, from about 20% to about 40%, from about 20% to about 30%, from about 30% to about 90%, from about 30% to about 80%, from about 30% to about 70%, from about 30% to about 60%, from about 30% to about 50%, from about 30% to about 40%, from about 40% to about 90%, from about 40% to about 80%, from about 40% to about 70%, from about 40% to about 60%, from about 40% to about 50%, from about 50% to about 90%, from about 50% to about 80%, from about 50% to about 70%, from about 50% to about 60%, from about 60% to about 90%, from about 60% to about 80%, from about 60% to about 70%, from about 70% to about 90%, from about 70% to about 80%, or from about 80% to about 90%.

In various embodiments, a file containing the data structure defining the boundary of the cell. In some embodiments, the file comprises definitions of about 1, about 10, about 100, about 1000, about 10K, about 100K, about 200K, about 500K, about 1 M, about 5 M, about 10 M, or about 100 M cell boundaries. In some embodiments, the file comprises definitions of at least about 1, at least about 10, at least about 100, at least about 1000, at least about 10K, at least about 100K, at least about 200K, at least about 500K, at least about 1 M, at least about 5 M, at least about 10 M, or at least about 100 M cell boundaries. In some embodiments, the file comprises definitions of from about 1 to about 10, from about 1 to about 100, from about 1 to about 1000, from about 1 to about 10K, from about 1 to about 100K, from about 1 to about 200K, from about 1 to about 500K, from about 1 to about 1 M, from about 1 to about 5 M, from about 1 to about 10 M, from about 1 to about 100 M, from about 10 to about 100, from about 10 to about 1000, from about 10 to about 10K, from about 10 to about 100K, from about 10 to about 200K, from about 10 to about 500K, from about 10 to about 1 M, from about 10 to about 5 M, from about 10 to about 10 M, from about 10 to about 100 M, from about 100 to about 1000, from about 100 to about 10K, from about 100 to about 100K, from about 100 to about 200K, from about 100 to about 500K, from about 100 to about 1 M, from about 100 to about 5 M, from about 100 to about 10 M, from about 100 to about 100 M, from about 1000 to about 10K, from about 1000 to about 100K, from about 1000 to about 200K, from about 1000 to about 500K, from about 1000 to about 1 M, from about 1000 to about 5 M, from about 1000 to about 10 M, from about 1000 to about 100 M, from about 10K to about 100K, from about 10K to about 200K, from about 10K to about 500K, from about 10K to about 1 M, from about 10K to about 5 M, from about 10K to about 10 M, from about 10K to about 100 M, from about 100K to about 200K, from about 100K to about 500K, from about 100K to about 1 M, from about 100K to about 5 M, from about 100K to about 10 M, from about 100K to about 100 M, from about 200K to about 500K, from about 200K to about 1 M, from about 200K to about 5 M, from about 200K to about 10 M, from about 200K to about 100 M, from about 500K to about 1 M, from about 500K to about 5 M, from about 500K to about 10 M, from about 500K to about 100 M, from about 1 M to about 5 M, from about 1 M to about 10 M, from about 1 M to about 100 M, from about 5 M to about 10 M, from about 5 M to about 100 M, or from about 10 M to about 100 M cell boundaries. GUI

In various embodiments, the methods, systems, and media disclosed herein further comprises a client-side computing device. In various embodiments, the methods, systems, and media disclosed herein further comprises rendering the cell boundaries on a GUI. In some embodiments further comprises rendering on a GUI for about of about 1, about 10, about 100, about 1000, about 10K, about 100K, about 200K, about 500K, about 1 M, about 5 M, about 10 M, or about 100 M cell boundaries. In some embodiments further comprises rendering on a GUI for at least about 1, at least about 10, at least about 100, at least about 1000, at least about 10K, at least about 100K, at least about 200K, at least about 500K, at least about 1 M, at least about 5 M, at least about 10 M, or at least about 100 M cell boundaries. In some embodiments further comprises rendering on a GUI for from about 1 to about 10, from about 1 to about 100, from about 1 to about 1000, from about 1 to about 10K, from about 1 to about 100K, from about 1 to about 200K, from about 1 to about 500K, from about 1 to about 1 M, from about 1 to about 5 M, from about 1 to about 10 M, from about 1 to about 100 M, from about 10 to about 100, from about 10 to about 1000, from about 10 to about 10K, from about 10 to about 100K, from about 10 to about 200K, from about 10 to about 500K, from about 10 to about 1 M, from about 10 to about 5 M, from about 10 to about 10 M, from about 10 to about 100 M, from about 100 to about 1000, from about 100 to about 10K, from about 100 to about 100K, from about 100 to about 200K, from about 100 to about 500K, from about 100 to about 1 M, from about 100 to about 5 M, from about 100 to about 10 M, from about 100 to about 100 M, from about 1000 to about 10K, from about 1000 to about 100K, from about 1000 to about 200K, from about 1000 to about 500K, from about 1000 to about 1 M, from about 1000 to about 5 M, from about 1000 to about 10 M, from about 1000 to about 100 M, from about 10K to about 100K, from about 10K to about 200K, from about 10K to about 500K, from about 10K to about 1 M, from about 10K to about 5 M, from about 10K to about 10 M, from about 10K to about 100 M, from about 100K to about 200K, from about 100K to about 500K, from about 100K to about 1 M, from about 100K to about 5 M, from about 100K to about 10 M, from about 100K to about 100 M, from about 200K to about 500K, from about 200K to about 1 M, from about 200K to about 5 M, from about 200K to about 10 M, from about 200K to about 100 M, from about 500K to about 1 M, from about 500K to about 5 M, from about 500K to about 10 M, from about 500K to about 100 M, from about 1 M to about 5 M, from about 1 M to about 10 M, from about 1 M to about 100 M, from about 5 M to about 10 M, from about 5 M to about 100 M, or from about 10 M to about 100 M cell boundaries.

### EXAMPLES

The following illustrative examples are representative of embodiments of the software applications, systems, and methods described herein and are not meant to be limiting in any way.

### Example 1

### Validation on Fast Polygon Self-Intersecting Test For Moving Vertex

The fast polygon self-intersecting test algorithm geometrically increases in performance as the number of vertices increases compared to the common brute force method. JavaScript coding the fast polygon self-intersection test for moving vertex was tested against the conventional brute force algorithm on a web browser (Microsoft Edge). For a 50-vertex polygon, the fast polygon self-intersection test performed 100 times faster than the conventional algorithm. For a 100-vertex polygon it was 1,000 times faster.

### Example 2

### Validation on Cell Segmentation Images

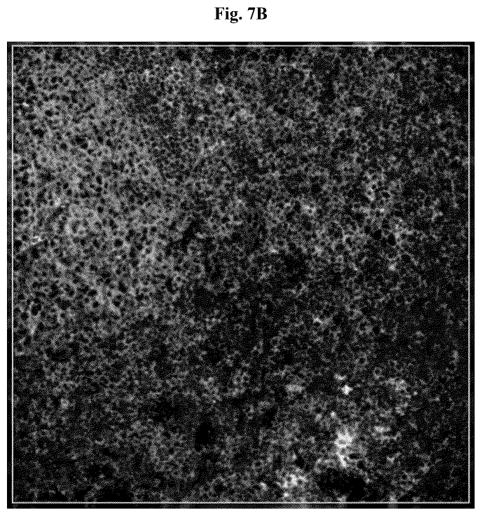

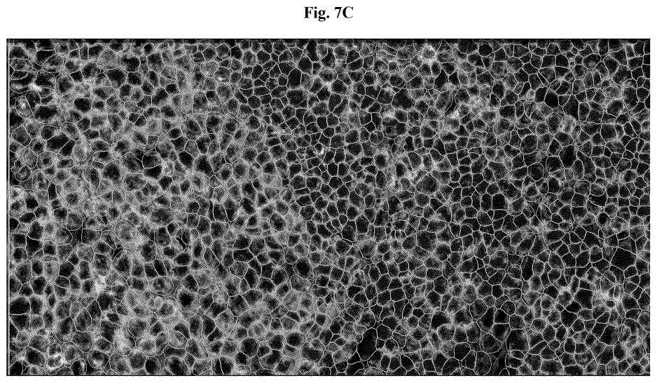

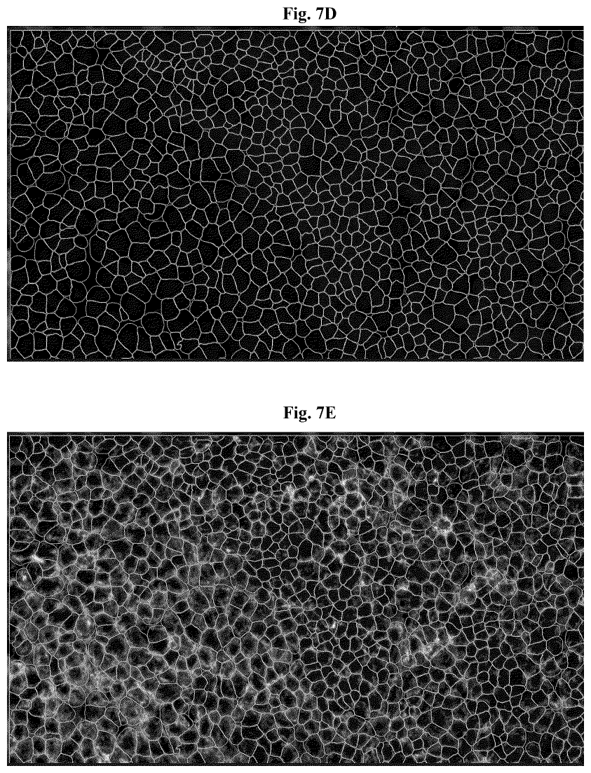

A 1000-plex RNA assay was performed on the CosMx™ Spatial Multi-omics Single-Cell Imaging Platform for human tonsil sections. As illustrated in FIG. 7A, a non-limiting example of biological cell image was displayed after the cell segmentation process. Field of view (FOV) was distributed evenly across the tonsil to survey expression in germinal centers, compared with regions adjacent to germinal center. The sample was stained with DAPI (where nuclei appear blue), and CD298/B2M (where membranes appear yellow). As shown in FIG. 7A, each cell boundary was clearly displayed around a nucleus, after a cell segmentation process applying the methods, systems, and media disclosed herein; while comparing to FIG. 7B, a display of the cell image with the same FOV prior to cell segmentation. Illustrated in FIG. 7C is a zoomed in view of the display with the same FOV. FIG. 7D illustrates a zoomed in display of cell segmentation with only the nuclear staining; while FIG. 7E illustrates a zoomed in display of cell segmentation with both nuclear and membrane staining.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented method of generating a file defining biological image data comprising operations of:
a) retrieving, by a computer, cartesian coordinates of vertices of a non-intersecting polygon, and maintaining the vertices in an order from a starting vertex to a last vertex, following a polygon path around a boundary of a cell from a biological image;
b) storing in a data structure, by the computer, the cartesian coordinates of the starting vertex of the polygon;
c) calculating, by the computer, a distance between the starting vertex and the last vertex;
d) selecting, by the computer, a matrix comprising edge elements to represent different directions based on the distance;
e) assigning, by the computer, the cartesian coordinates of a first vertex from a pair of ordered neighboring vertices as a polar reference coordinate of the matrix;
f) converting, by the computer, the cartesian coordinates of a second vertex from the pair of ordered neighboring vertices into a reference to the polar coordinates of a corresponding matrix;
g) assigning, by the computer, a step for the first vertex from the pair of ordered neighboring vertices as an edge element of the second vertex combining a size of the matrix;
h) storing in the data structure, by the computer, the step for the vertex in the order along the polygon path;
i) storing in the data structure, by the computer, the steps for all vertices, by iterating operations e)-h); and
j) generating, by the computer, from the data structure, a file defining the boundary of the cell.

2. The method of claim 1, wherein the vertices are maintained in an array.

3. The method of claim 1, further comprising performing, by the computer, a quality assurance check on received cartesian coordinates of vertices of a non-intersecting polygon, wherein the quality assurance check comprises one or more of:
a) checking that the polygon comprises at least 3 vertices;
b) checking that the polygon path comprises a closed loop;
c) checking that polygon path comprises an established direction; and
d) checking that the order of the vertices following the polygon path comprises a
sequential order.

4. The method of claim 1, wherein the matrix comprises a 3×3, 4×4, 5×5, 6×6, 7×7, 8×8, 9×9, 10x10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, or 33×33 matrix.

5. The method of claim 1, wherein the data structure comprises 1-bit, 2-bit, 3-bit, 4-bit, 5-bit, 6-bit, 7-bit, or 8-bit for storing each step.

6. The method of claim 1, wherein the data structure comprises 1-byte, 2-byte, 3-byte, or 4-byte for storing each step.

7. The method of claim 1, wherein operation h) further comprises storing a terminator for the last vertex of the polygon.

8. The method of claim 1, further comprising receiving the biological image which is either a 2D image or a 3D image, and wherein the cartesian coordinates are either 2D coordinates of the 2D image or 3D coordinates of the 3D image.

9. The method of claim 1, wherein the distance comprises Euclidean distance.

10. The method of claim 1, wherein the distance comprises a difference in cartesian coordinates of one dimension.

11. The method of claim 1, wherein the distance comprises a maximum value of a difference in cartesian coordinates of all dimensions.

12. The method of claim 1, wherein the distance comprises a minimum value of a difference in cartesian coordinates of all dimensions.

13. The method of claim 1, wherein the distance comprises an arithmetic average value of a difference in cartesian coordinates of all dimensions.

14. The method of claim 1, further comprising compressing, by the computer, the data in the data structure for all vertices of the boundary of the cell.

15. The method of claim 1, wherein the computer comprises a client-side computing device.

16. The method of claim 1, further comprising rendering the cell boundaries on a GUI.

17. The method of claim 16, further comprising rendering at least 100K, 500K, 1 M, 5 M, or 10 M cell boundaries.

18. The method of claim 1, wherein the file comprises definitions of at least 100K, 500K, 1 M, 5 M, or 10 M cell boundaries.

19. A computer-implemented system comprising at least one processor and instructions executable by the at least one processor to provide an application comprising:
a) a software module retrieving cartesian coordinates of vertices of a non-intersecting polygon, and maintaining the vertices in an order from a starting vertex to a last vertex, following a polygon path around a boundary of a cell from a biological image;
b) a software module storing, in a data structure, the cartesian coordinates of the starting vertex of the polygon;
c) a software module calculating a distance between the starting vertex and the last vertex;
d) a software module selecting a matrix comprising edge elements to represent different directions based on the distance;
e) a software module assigning the cartesian coordinates of a first vertex from a pair of ordered neighboring vertices as a polar reference coordinate of the matrix;
f) a software module converting the cartesian coordinates of a second vertex from the pair of ordered neighboring vertices into a reference to the polar coordinates of a corresponding matrix;
g) a software module assigning a step for the first vertex from the pair of ordered neighboring vertices as an edge element of the second vertex combining a size of the matrix;
h) a software module storing, in the data structure, the step for the vertex in the order along the polygon path;
i) a software module storing, in the data structure, the steps for all vertices, by iterating e)-h); and
j) a software module generating, from the data structure, a file defining the boundary of the cell.

20. Non-transitory computer-readable storage media encoded with instructions executable by one or more processors to cause the one or more processors to perform operations comprising:
a) retrieving cartesian coordinates of vertices of a non-intersecting polygon;
b) maintaining the vertices in an order from a starting vertex to a last vertex, following a polygon path around a boundary of a cell from a biological image;
c) storing, in a data structure, the cartesian coordinates of the starting vertex of the polygon;
d) calculating a distance between the starting vertex and the last vertex;
e) selecting a matrix comprising edge elements to represent different directions based on the distance;
f) assigning the cartesian coordinates of a first vertex from a pair of ordered neighboring vertices as a polar reference coordinate of the matrix;
g) converting the cartesian coordinates of a second vertex from the pair of ordered neighboring vertices into a reference to the polar coordinates of a corresponding matrix;
h) assigning a step for the first vertex from the pair of ordered neighboring vertices as an edge element of the second vertex combining a size of the matrix;
i) storing, in the data structure, the step for the vertex in the order along the polygon path;
j) storing, in the data structure, the steps for all vertices, by iterating f)-i); and
k) generating, from the data structure, a file defining the boundary of the cell.
